(19) United States
(12) Patent Application Publication
(10) Pub. No.: US 2010/0177074 A1
(43) Pub. Date: Jul. 15, 2010

(54) DRIVE METHOD OF INFORMATION DISPLAY PANEL

(75) Inventors: Takumi Saito, Kodaira-shi (JP); Koji Takao, Kodaira-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Chuo-ku, Tokyo (JP)

(21) Appl. No.: 12/668,584

(22) PCT Filed: Jul. 11, 2008
(86) PCT No.: PCT/JP2008/062614

§ 371 Date: Feb. 25, 2010

(30) Foreign Application Priority Data
Jul. 12, 2007 (JP) 2007-183534

(51) Int. Cl. G06F 3/038

(52) U.S. Cl. 345/206; 345/107

(57) ABSTRACT

A drive method of an information display panel, in which display media is sealed in a space between the substrates, at least one of which is transparent, and an electric field is applied to display media by application of a pulse voltage between electrodes provided each of the substrates opposed one another so as to display information such as an image, is to lower the pulse voltage by setting a circuit between the electrodes, to which the pulse voltage is applied, a high impedance state. Thereby, it can provide the drive method of the information display panel capable of achieving high contrast.

### TECHNICAL FIELD

The present invention relates to a drive method of an information display panel, which is constituted of two substrates, at least one of which is transparent, and display media sealed therebetween, for displaying information such as an image by applying a pulse voltage between electrodes provided to each of the substrates facing one another so as to apply an electric field to the display media.

### RELATED ART

FIG. 10 is a diagram showing a part of a conventional information display panel for explaining a drive method thereof. A display part of a single pixel is shown in FIG. 10 as the part of the information display panel. An information display method of the conventional information display panel is described by use of an example shown in FIG. 10 as follows: first, display media 53, composed of a white color display media 53W and a black color display media 53B both having an electrostatic polarity different from one another, is sealed in a space formed of partition walls 54 between two substrates 51, 52, at least one of which is transparent. Then, a predetermined pulse voltage is applied between electrodes 55, 56 provided to the substrates 51, 52, respectively, which are facing one another, from a power source 57 so as to apply an electric field to the display media 53. At this point, the white color display media 53W or the black color display media 53B are moved in each pixel by change of polarities of the pulse voltage applied to the electrodes 55, 56, so as to display each pixel in white color or black color and thus to display information such as an image.

In the above conventional information display panel, the display media 53, which is charged by application of the pulse voltage between the electrodes 55, 56, are moved and a current flows with the movement of the display media 53 (charge). It is known that a current value flowing indicates a displacement of the display media 53 (for example, Japanese Patent Laid-Open Publication No. 2004-54227).

Inventors of the present invention, based on the above knowledge, examined the current between the electrodes 55, 56 in the panel constituted as exemplified in FIG. 10, at raise/lowering of the voltage when the pulse voltage was applied. FIG. 11 is a graph explaining conditions of the current at raise/lowering of the voltage when the pulse voltage was applied in the conventional information display panel. As shown by an example shown in FIG. 11, an invert of the white color and the block color is occurred because of movement of the display media 53 as the current flows instantaneously at raise of the voltage when the pulse voltage is applied, although the display media 53 do not move after a predetermined period and thus the current does not flow. At this time, the current restores to 0 and does not flow in a minus direction, thus there is no adverse flow of the display media 53.

On the other hand, when the voltage being applied was set to 0V at lowering of the voltage when the pulse voltage was removed, the current exceeded 0 and flew in the minus direction for a moment, as shown in FIG. 11. This means that the display media 53 moved in a direction opposite to the direction to invert the display media 53, thus the current flowing in the minus direction caused lower contrast.

### DISCLOSURE OF THE INVENTION

An object of the present invention is to provide a drive method of an information display panel which can achieve high contrasts by eliminating the problem stated above.

According to the present invention, the drive method of the information display panel constituted of two substrates, at least one of which is transparent, and display media sealed therebetween, for displaying information such as an image by applying a pulse voltage between electrodes provided to each of the substrates facing one another so as to apply an electric field to the display media, is characterized in lowering the pulse voltage by setting a circuit between the electrodes, to which the pulse voltage is applied, a high impedance state.

In preferable embodiments of the drive method of the information display panel, the high impedance state is achieved by disconnection of the circuit between the electrodes, and the display media are a particle group or liquid powder composed of at least one kind of particles.

According to the present invention, it is possible to obtain the drive method of the information display panel which can achieve high contrasts, by setting the circuit between the electrodes, to which the pulse voltage is applied, the high impedance state so as to lower the pulse voltage.

### BRIEF DESCRIPTION OF THE DRAWINGS

FIGS. 1a and 1b are diagrams respectively exemplifying an information display panel as an object of a drive method according to the present invention.

FIGS. 2a and 2b are diagrams respectively exemplifying another information display panel as an object of the drive method according to the present invention.

FIGS. 3a and 3b are diagrams respectively exemplifying yet another information display panel as an object of the drive method according to the present invention.

FIG. 4 is a diagram exemplifying yet another information display panel as an object of the drive method according to the present invention.

FIG. 5 is a diagram exemplifying yet another example of the information display panel as an object of the drive method according to the present invention.

FIG. 6 is a diagram explaining the drive method of the information display panel according to the present invention.

FIG. 7 is a graph explaining conditions of a current at raise/lowering of the pulse voltage when a pulse voltage is applied in the information display panel according to the present invention.

FIG. 8 is a diagram showing examples of forms of partition walls of the information display panel as an object of the present invention.

FIG. 9 is a graph exemplifying a pattern to apply a voltage by a drive method according to examples of the present invention and of a conventional art used in the embodiments.

FIG. 10 is a diagram showing a part of a conventional information display panel for explaining a drive method thereof.

FIG. 11 is a graph explaining conditions of a current at raise/lowering of the pulse voltage when a pulse voltage is applied in the conventional information display panel.

### BEST MODE FOR CARRYING OUT THE INVENTION

First, it is described about a basic construction of an exemplified information display panel as an object of the invention. In the information display panel as the object of the present invention, an electrostatic field is applied to display media sealed between two opposed substrates. Charged particles are attracted along a direction of electrostatic field to be applied by means of Coulomb's force in such a manner that the particles charged at a low potential are attracted toward a high potential side and the particles charged at a high potential are attracted toward a low potential side, and thus the particles can be moved reciprocally by varying a direction of electrostatic field due to a switching operation of potential. Accordingly, an image can be displayed. Therefore, it is necessary to design the information display panel in such a manner that the display media can move evenly and maintain stability during a reciprocal operation or during a reserving state. Here, in the case of using particles or liquid powders as the display media, as to forces applied to the particles, there are an attraction force between the particles due to Coulomb' force, an imaging force with respect to the electrode panel, an intermolecular force, a liquid bonding force and a gravity.

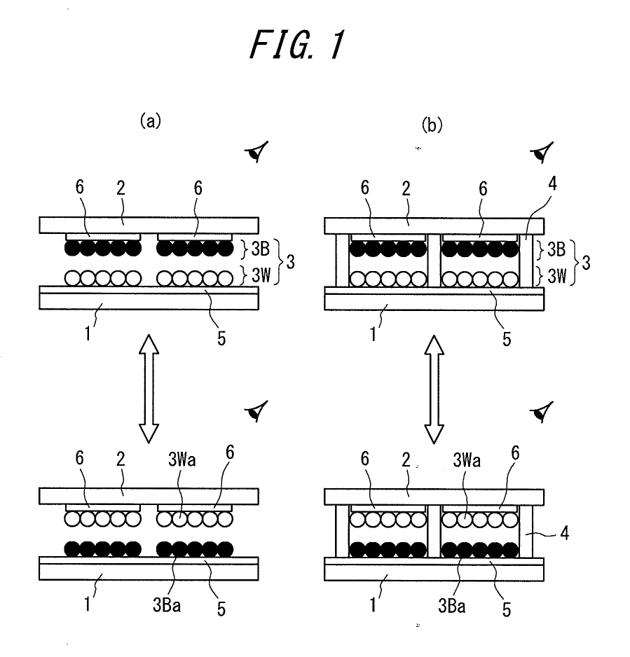

Examples of the information display panel which is an object of a drive method according to the invention will be explained with reference to FIGS. 1a and 1b-FIG. 5.

In the examples shown in FIGS. 1a and 1b, at least two or more groups of display media 3 having different optical reflectance and charge characteristic and consisting of at least one or more groups of particles (here, white color display media 3W made of the particles constituted by particles 3Wa for white color display media and black color display media 3B made of the particles constituted by particles 3Ba for black color display media) are moved in a perpendicular direction with respect to substrates 1 and 2, in accordance with an electric field generated by application of a voltage between an electrode 5 provided inside the substrate 1 and an electrode 6 provided inside the substrate 2. Then, a black color display and a white color display is performed by having an observer view the black color display media 3B or the white color display media 3W. It is to be noted that, in the example shown in FIG. 1b, partition walls 4 in a reticular pattern, for example, is provided between the substrates 1, 2 in addition to the information display panel exemplified in FIG. 1a. In addition, the partition walls arranged at a front side are omitted in FIG. 1b.

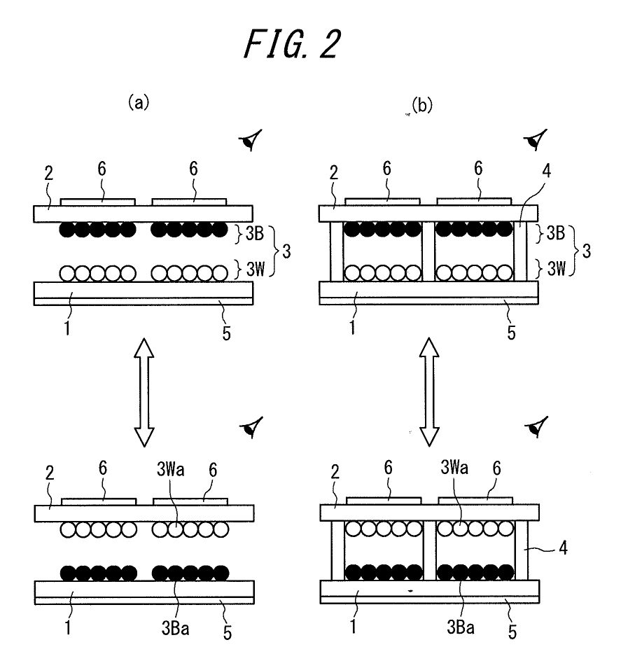

In the examples shown in FIGS. 2a and 2b, at least two or more groups of display media 3 having different optical reflectance and charge characteristic and consisting of at least one or more groups of particles (here, white color display media 3W made of the particles constituted by particles 3Wa for white color display media and black color display media 3B made of the particles constituted by particles 3Ba for black color display media) are moved in the perpendicular direction with respect to substrates 1 and 2, in accordance with the electric field generated by application of the voltage between the electrode 5 provided outside the substrate 1 and the electrode 6 provided outside the substrate 2. Then, the black color display and the white color display is performed by having the observer view the black color display media 3B or the white color display media 3W, respectively. It is to be noted that, in the example shown in FIG. 2b, partition walls 4 are provided in the rectangular pattern, for example, between the substrates 1, 2 in addition to the example shown in FIG. 2a, so as to form cells. In addition, the partition walls arranged at the front side are omitted in FIG. 2b.

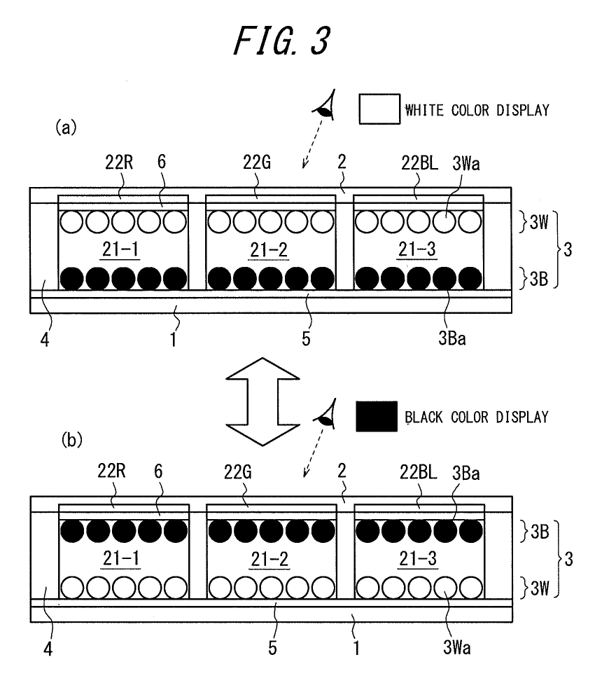

In the examples shown in FIGS. 3a and 3b, a color display utilizing a unit pixel constituted by three cells is explained. In the examples shown in FIGS. 3a and 3b, the white color display media 3W and the black color display media 3B as the display media are filled in all cells 21-1 to 21-3, and a red color filter 22R, a green color filter 22G and a blue color filter 22BL are provided to the first cell 21-1, the second sell 21-2, and the third cell 21-3, respectively, at the observer's side of the cells, so as to constitute a unit pixel by the first cell 21-1, the second cell 21-2 and the third cell 21-3. In this embodiment, the white color display is performed for the observer by arranging the white color display media 3W to all the first cell 21-1 to the third cell 21-3 at the observer's side as shown in FIG. 3a, the black color display is performed for the observer by arranging the black color display media 3B to all the first cell 21-1 to the third cell 21-3 at the observer's side, as shown in FIG. 3b. It is to be noted that the partition walls arranged at the front side are omitted in FIGS. 3a, 3b.

The above explanations can be applied to a case where the white color display media 3W made of the particles are substituted by white color display media composed of the liquid powders or a case where the black color display media 3B composed of the particles are substituted by black color display media made of the liquid powders. As set forth above, the electrodes can be provided outside the substrates or embedded in the substrates.

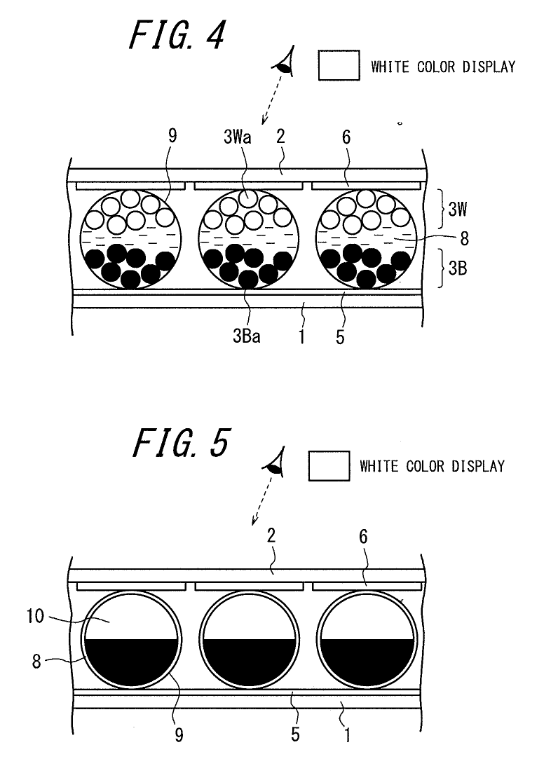

Examples shown in FIG. 4 and FIG. 5 explaining other embodiments to perform the white/black color display by use of the line electrodes 5 and 6 used in the example in FIG. 1b. In the example shown in FIG. 4, a micro capsule 9, filled with the white color display media 3W and the black color display media 3B together with an insulation liquid 8, is used instead of the cell formed by the partition walls 4 filled with the white color display media 3W and the black color display media 3B as shown in FIG. 1b. In the example shown in FIG. 5, a micro capsule 9 filled with a rotation ball 10, as the display media, having its surface painted in white color on one half thereof and in black color on the other half thereof, each of which has a polarity opposite to one another, together with the insulation liquid 8, is used instead of the cell formed by the partition walls 4, in which the white color display media 3W and the black color display media 3B are filled as shown in FIG. 1b. Like the embodiment shown in FIG. 1b, the white/black color display can be performed in the both embodiments shown in FIG. 4 and FIG. 5.

The present invention is characterized in turning off the pulse voltage by setting a circuit between the electrodes, to which the pulse voltage is applied, a high impedance state. That is, what is characteristic is to set the high impedance state in order to lower a waveform of the pulse voltage, instead of setting the voltage 0V as conventionally performed.

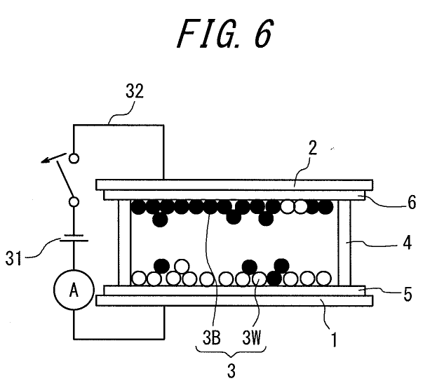

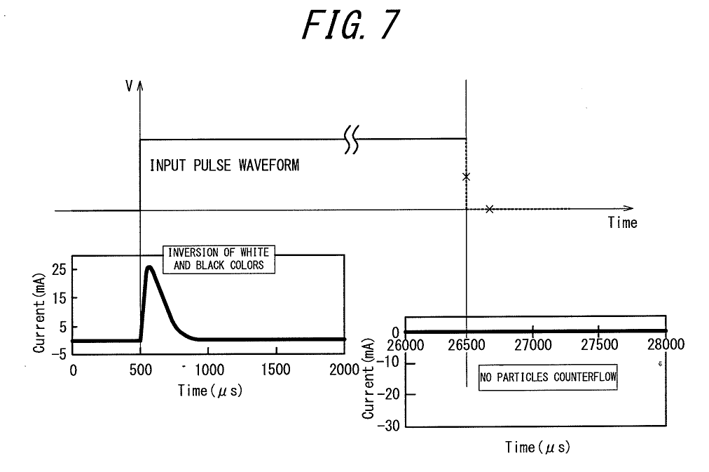

FIG. 6 is a diagram explaining the drive method of the information display panel according to the present invention. In FIG. 6, a display part of a single pixel is shown as a part of the information display panel. In an example shown in FIG. 6, a circuit constituted of a power source 31 and a switch 32 is provided between the electrodes 5, 6, so as to apply the pulse voltage between the electrodes 5, 6 by turning on the switch 32. The switch 32 is turned on so as to raise the pulse voltage, while the switch 32 is turned on to disconnect the circuit so as to lower the pulse voltage, instead of setting the voltage 0V as conventionally performed, thereby the circuit between the electrodes 5, 6 is set the high impedance state. That is, resistance of the switch 32 of the circuit is set to be high, or infinite in this example, so as to achieve the high impedance state.

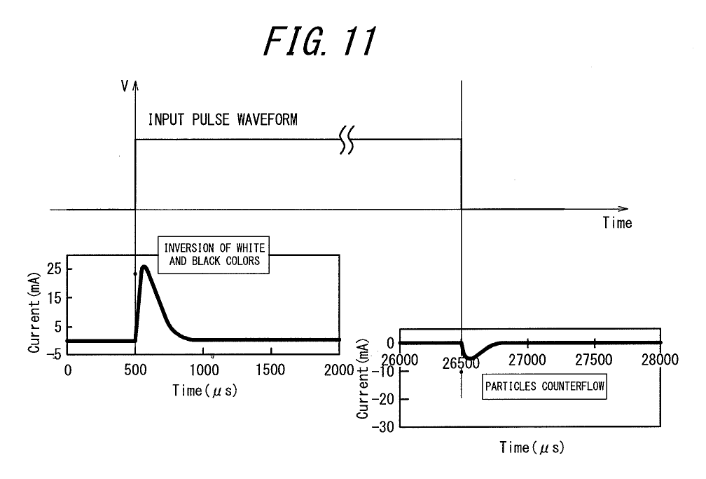

FIG. 7 is a graph explaining a condition of a current at raise/lowering of the pulse voltage, when the pulse voltage is applied, in the information display panel according to the present invention. As shown in an example in FIG. 7, a current flows instantaneously at raise of the voltage and the display media 3 move when the pulse voltage is applied, causing an invert of the white color and the block color, and the display media 3 settle down and no current flows after a certain period. At this point, the current converges to 0 and does not flow in the minus direction, thus there is no counterflow of the display media 3. This example at raise of the voltage is the same as a condition of a current of a conventional information display panel (example of a conventional panel shown in FIG. 11).

On the other hand, in the example shown in FIG. 7, when the voltage lowers at removal of the pulse voltage, the switch 32 provided to the circuit between the electrodes 5, 6 is turned off to disconnect the circuit so as to set the high impedance state, instead of setting the voltage 0V as conventionally performed. By setting the high impedance state in such a manner, the circuit between the electrodes 5, 6 is disconnected as shown in FIG. 7, thereby no current flows on the circuit. As a result, the display media 3 do not move in an opposite direction and thus contrast is not lowered.

Although a panel of a passive matrix drive (writing an image by row) is used as the example in the above description of the information display panel according to the present invention, the present invention is not limited thereto but also applicable to a panel of an active matrix drive. This is because, since the information display panel as a subject of the present invention has a memory property capable of maintaining an image after a power source is turned off, it is no problem to turn the power source off after writing.

Moreover, in addition to that the pulse voltage is lowered by setting the circuit between the electrodes, to which the pulse voltage is applied, the high impedance state in the above description of the information display panel according to the present invention, it is preferred to maintain the high impedance state until a next rewrite. Thereby, it can minimize movement of the display media until the next rewrite.

The followings are explanations about members constituting the information display panel as the object of the drive method according to the present invention.

As for the substrates, at least one of the substrates is the substrate 2, which is transparent such that a color of the display media 3 can be observed therethrough from outside of the panel, and preferably made of a material having a high transmission factor of visible light and an excellent heat resistance. The other substrate 1 may be either transparent or opaque. Examples of the materials for the substrate include polymer sheets such as polyethylene terephthalate, polyethylene naphthalate, polyether sulfone, polyethylene, polycarbonate, polyimide or acryl and metal sheets having flexibility and inorganic sheets such as glass, quartz or so having no flexibility. The thickness of the substrate is preferably 2 to 5000 μm, more preferably 5 to 2000 μm. When the substrate is too thin, it becomes difficult to maintain strength and distance uniformity between the substrates, while it is inexpedient to be used for a slim information display panel when the substrate is thicker than 5000 μm.

As for the electrodes, a material suitably selected to form the electrodes is a metal such as aluminum, silver, nickel, copper, gold and the likes, conductive metal oxides such as indium tin oxide (ITO), antimony tin oxide (ATO), indium oxide, conductive tin oxide and conductive zinc oxide and the likes, or conductive polymers such as polyaniline, polypyrrole, polythiophene and the likes. In order to form the electrodes, adoptable methods are a method for forming a pattern on a film of the above material by such as sputtering method, vacuum vapor deposition method, CVD (chemical vapor deposition) method, coating method and the likes, or a method to mix conductive materials with solvents or synthetic resin binder and spray a mixture thereof. A transparency is necessary for the electrode arranged to the substrate 2 at an observation side (display surface side), whereas that is not necessary to the substrate 1 at a rear side. In both cases, the materials stated above, which are transparent and have a pattern formation capability, can be suitably used. Additionally, the thickness of the electrode may be suitable unless the electro-conductivity is absent or any hindrance exists in optical transparency, and it is preferable to be 3 to 1000 nm, more preferable to be 5 to 400 nm. The material and the thickness of the electrode arranged to the rear substrate 1 are the same as those of the electrode arranged to the substrate at the display side, whereas transparency is not necessary. In this case, the applied external voltage may be superimposed with a direct current or an alternate current.

Although a shape of the partition wall 4, which is arranged to the substrate as necessary, is suitably designed in accordance with a kind of the display media, a shape of the electrodes disposed and positions and not limited, it is preferred to set a width of the partition wall 2-100 μm, more preferably 3-50 μm and to set a height of the partition wall 10-100 μM, more preferably 10-50 μm.

Moreover, as a method of forming the partition wall, use may be made of a double rib method wherein ribs are formed on the opposed substrates respectively and they are connected with each other and a single rib method wherein a rib is formed on one of the opposed substrates only. The present invention may be preferably applied to both methods mentioned above.

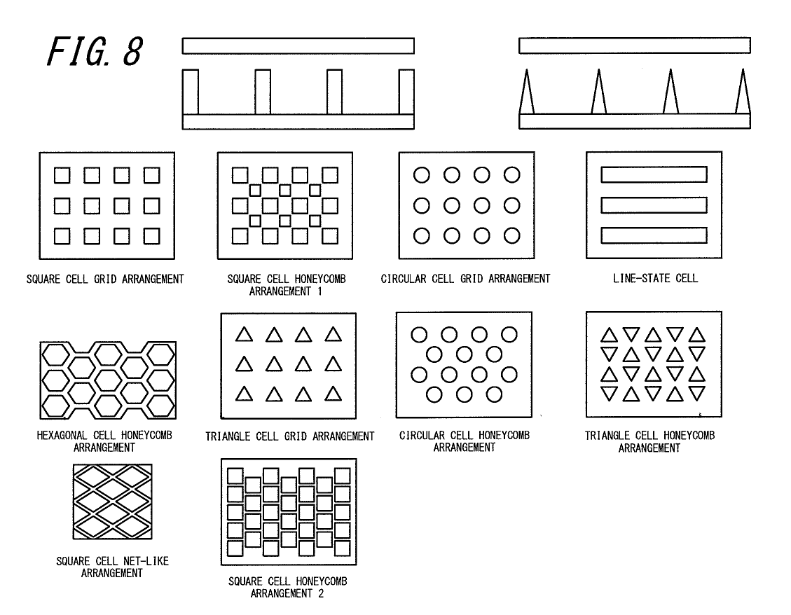

The cell formed by the partition walls each made of rib has a square shape, a triangular shape, a line shape, a circular shape and a hexagon shape, and has an arrangement such as a grid, a honeycomb and a mesh, as shown in FIG. 8 viewed from a plane surface of the substrate. It is preferred that the portion corresponding to a cross section of the partition wall observed from the display side (an area of the frame portion of the display cell) should be made as small as possible. In this case, a clearness of the image display can be improved.

The formation method of the partition wall is not particularly restricted, however, a die transfer method, a screen-printing method, a sandblast method, a photolithography method and an additive method. Among them, it is preferred to use a photolithography method using a resist film or a die transfer method.

Next, liquid powders used as for example display media in the information display panel according to the invention will be explained. It should be noted that a right of the name of liquid powders used in the information display panel according to the invention is granted to the applicant as “liquid powders” (Registered): register No. 4636931.

In the present invention, a term “liquid powders” means an intermediate material having both of liquid properties and particle properties and exhibiting a self-fluidity without utilizing gas force and liquid force. Preferably, it is a material having an excellent fluidity such that there is no repose angle defining a fluidity of powder. For example, a liquid crystal is defined as an intermediate phase between a liquid and a solid, and has a fluidity showing a liquid characteristic and an anisotropy (optical property) showing a solid characteristic (Heibonsha Ltd.: encyclopedia). On the other hand, a definition of the particle is a material having a finite mass if it is vanishingly small and receives an attraction of gravity (Maruzen Co., Ltd.: physics subject-book). Here, even in the particles, there are special states such as gas-solid fluidized body and liquid-solid fluidized body. If a gas is flown from a bottom plate to the particles, an upper force is acted with respect to the particles in response to a gas speed. In this case, the gas-solid fluidized body means a state that is easily fluidized when the upper force is balanced with the gravity. In the same manner, the liquid-solid fluidized body means a state that is fluidized by a liquid. (Heibonsha Ltd.: encyclopedia) In the present invention, it is found that the intermediate material having both of fluid properties and solid properties and exhibiting a self-fluidity without utilizing gas force and liquid force can be produced specifically, and this is defined as the liquid powder.

That is, as is the same as the definition of the liquid crystal (intermediate phase between a liquid and a solid), the liquid powders according to the invention are a material showing the intermediate state having both of liquid properties and particle properties, which is extremely difficult to receive an influence of the gravity showing the particle properties mentioned above and indicates a high fluidity. Such a material can be obtained in an aerosol state i.e. in a dispersion system wherein a solid-like or a liquid-like material is floating in a relatively stable manner as a dispersant in a gas, and thus, in the information display device according to the invention, a solid material is used as a dispersant.

The information display panel as a target of the present invention has a construction in which the liquid powder composed of a solid material stably floating as a dispersoid in a gas and exhibiting a high fluidity in an aerosol state are sealed between opposed two substrates, one of which is transparent. Such liquid powder has fluidity so high that a repose angle, an index indicating fluidity of powder, cannot be measured, and can be moved easily and stably by means of Coulomb's force and so on generated by applying a low voltage.

As mentioned above, the liquid powders mean an intermediate material having both of liquid properties and particle properties and exhibiting a self-fluidity without utilizing gas force and liquid force. Such liquid powders become particularly an aerosol state. In the information display device according to the invention, the liquid powder used in a state such that a solid material is relatively and stably floating as the dispersoid in the gas.

Next, the particles for the display media (hereinafter, called sometimes as particles) constituting the display media used in the information display panel according to the present invention will be explained. The particles for the display media may be used as the display media constituted by the particles only, or, as the display media constituted by mixing various groups of the particles, or, as the display media constituted by the liquid powders obtained by controlling and mixing the particles.

The particle may be composed of resins as a main ingredient, and can include according to need charge control agents, coloring agent, inorganic additives and so on as is the same as the known one. Hereinafter, typical examples of resin, charge control agent, coloring agent, additives and so on will be explained.

Typical examples of the resin include urethane resin, urea resin, acrylic resin, polyester resin, acryl urethane resin, acryl urethane silicone resin, acryl urethane fluorocarbon polymers, acryl fluorocarbon polymers, silicone resin, acryl silicone resin, epoxy resin, polystyrene resin, styrene acrylic resin, polyolefin resin, butyral resin, vinylidene chloride resin, melamine resin, phenolic resin, fluorocarbon polymers, polycarbonate resin, polysulfon resin, polyether resin, and polyamide resin. Two kinds or more of these may be mixed and used. For the purpose of controlling the attaching force with the substrate, acryl urethane resin, acryl silicone resin, acryl fluorocarbon polymers, acryl urethane silicone resin; acryl urethane fluorocarbon polymers, fluorocarbon polymers, silicone resin are particularly preferable.

Examples of the electric charge control agent include, but not particularly specified to, negative charge control agent such as salicylic acid metal complex, metal containing azo dye, oil-soluble dye of metal-containing (containing a metal ion or a metal atom), the fourth grade ammonium salt-based compound, calixarene compound, boron-containing compound (benzyl acid boron complex), and nitroimidazole derivative. Examples of the positive charge control agent include nigrosine dye, triphenylmethane compound, the fourth grade ammonium salt compound, polyamine resin, imidazole derivatives, etc. Additionally, metal oxides such as ultra-fine particles of silica, ultra-fine particles of titanium oxide, ultra-fine particles of alumina, and so on; nitrogen-containing circular compound such as pyridine, and so on, and these derivates or salts; and resins containing various organic pigments, fluorine, chlorine, nitrogen, etc. can be employed as the electric charge control agent.

As for a coloring agent, various kinds of organic or inorganic pigments or dye as will be described below are employable.

Examples of black pigments include carbon black, copper oxide, manganese dioxide, aniline black, and activate carbon.

Examples of blue pigments include C.I. pigment blue 15:3, C.I. pigment blue 15, Berlin blue, cobalt blue, alkali blue lake, Victoria blue lake, phthalocyanine blue, metal-free phthalocyanine blue, partially chlorinated phthalocyanine blue, first sky blue, and Indanthrene blue BC.

Examples of red pigments include red oxide, cadmium red, diachylon, mercury sulfide, cadmium, permanent red 4R, lithol red, pyrazolone red, watching red, calcium salt, lake red D, brilliant carmine 6B, eosin lake, rhodamine lake B, alizarin lake, brilliant carmine 3B, and C.I. pigment red 2.

Examples of yellow pigments include chrome yellow, zinc chromate, cadmium yellow, yellow iron oxide, mineral first yellow, nickel titanium yellow, navel orange yellow, naphthol yellow S, hanzayellow G, hanzayellow 10G, benzidine yellow G, benzidine yellow GR, quinoline yellow lake, permanent yellow NCG, tartrazinelake, and C.I. pigment yellow 12.

Examples of green pigments include chrome green, chromium oxide, pigment green B, C.I. pigment green 7,Malachite green lake, and final yellow green G.

Examples of orange pigments include red chrome yellow, molybdenum orange, permanent orange GTR, pyrazolone orange, Balkan orange, Indanthrene brilliant orange RK, benzidine orange G, Indanthrene brilliant orange GK, and C.I. pigment orange 31.

Examples of purple pigments include manganese purple, first violet B, and methyl violet lake.

Examples of white pigments include zinc white, titanium oxide, antimony white, and zinc sulphide.

Examples of extenders include baryta powder, barium carbonate, clay, silica, white carbon, talc, and alumina white. Furthermore, there are Nigrosine, Methylene Blue, rose bengal, quinoline yellow, and ultramarine blue as various dyes such as basic dye, acidic dye, dispersion dye, direct dye, etc.

Examples of inorganic additives include titanium oxide, zinc white, zinc sulphide, antimony oxide, calcium carbonate, pearl white, talc, silica, calcium silicate, alumina white, cadmium yellow, cadmium red, titanium yellow, Pressian blue, Armenian blue, cobalt blue, cobalt green, cobalt violet, ion oxide, carbon black, manganese ferrite black, cobalt ferrite black, copper powder, aluminum powder.

These coloring agents and inorganic additives may be used alone or in combination of two or more kinds thereof. Particularly, carbon black is preferable as the black coloring agent, and titanium oxide is preferable as the white coloring agent.

The particles for display media having a desired color can be produced by mixing the coloring agents mentioned above.

Moreover, as the average particle diameter d(0.5) of the particles for the display media (hereinafter, called sometimes as particles), it is preferred to set d(0.5) to 1-20 μM and to use even particles. If the average particle diameter d(0.5) exceeds this range, the image clearness sometimes deteriorated, and, if the average particle diameter is smaller than this range, an agglutination force between the particles becomes larger and the movement of the particles is prevented.

Further, it is preferred that particle diameter distribution Span of the particles, which is defined by the following formula, is less than 5 preferably less than 3:

Span=(d(0.9)−d(0.1))/d(0.5);

(here, d(0.5) means a value of the particle diameter expressed by μm wherein an amount of the particles having the particle diameter larger than or smaller than this value is 50%, d(0.1) means a value of the particle diameter expressed by μm wherein an amount of the particles having the particle diameter smaller than this value is 10%, and d(0.9) means a value of the particle diameter expressed by μm wherein an amount of the particles having the particle diameter smaller than this value is 90%).

If the particle diameter distribution Span of the particles is set to not more than 5, the particle diameter becomes even and it is possible to perform an even particle movement.

Furthermore, with regard to a correlation of each of the particles, it is preferred that a ratio of d(0.5) of the particles having. smallest diameter with respect to d(0.5) of the particles having largest diameter is not more than 50, preferably not more than 10 among the particles for display media. The particles having different charge characteristics with each other are moved reversely, even if the particle diameter distribution Span is made smaller. Therefore, it is preferred that the particle sizes of the particles are made to be even with each other, and the same amounts of the particles are easily moved in a reverse direction, which falls in this range.

Here, the particle diameter distribution and the particle diameter mentioned above can be measured by means of a laser diffraction/scattering method. When a laser light is incident upon the particles to be measured, a light intensity distribution pattern due to a diffraction/scattering light occurs spatially. This light intensity distribution pattern corresponds to the particle diameter, and thus it is possible to measure the particle diameter and the particle diameter distribution.

In the present invention, it is defined that the particle diameter and the particle diameter distribution are obtained by a volume standard distribution. Specifically, the particle diameter and the particle diameter distribution can be measured by means of a measuring apparatus Mastersizer 2000 (Malvern Instruments Ltd.) wherein the particles setting in a nitrogen gas flow are calculated by an installed analysis software (which is based on a volume standard distribution due to Mie's theory).

A charge amount of the display media properly depends upon the measuring condition. However, it is understood that the charge amount of the display media used for the display media in the information display panel substantially depends upon an initial charge amount, a contact with respect to the partition wall, a contact with respect to the substrate, a charge decay due to an elapsed time, and specifically a saturation value of the particles for the display media during a charge behavior is a main factor.

After various investigations of the inventors, it is fond that an adequate range of the charged values of the particles for the display media can be estimated by performing a blow-off method utilizing the same carrier particles so as to measure the charge amount of the particles for the display media.

Further, in the case that the display media such as the particles or the liquid powders are applied to a dry-type information'display panel, it is important to control a gas in a gap surrounding the display media between the substrates, and a suitable gas control contributes an improvement of display stability. Specifically, it is important to control a humidity of the gap gas to not more than 60% RH at 25° C., preferably not more than 50% RH.

The above gap means a gas portion surrounding the display media obtained by substituting the electrodes 5, 6 (in the case that the electrodes are arranged inside of the substrate), an occupied portion of the display media 3, an occupied portion of the partition walls 4 and a seal portion of the device from the space between the substrate 1 and the substrate 2 for example in FIGS. 1a and 1b-FIG. 5.

A kind of the gap gas is not limited if it has the humidity mentioned above, but it is preferred to use dry air, dry nitrogen gas, dry argon gas, dry helium gas, dry carbon dioxide gas, dry methane gas and so on. It is necessary to seal this gas in the device so as to maintain the humidity mentioned above. For example, it is important to perform the operations of filling the particles or the liquid powders and assembling the substrate under an atmosphere having a predetermined humidity and to apply a seal member and a seal method for preventing a humidity inclusion from outside of the device.

In the information display panel which is an object of the driving method according to the invention, an interval between the substrates is not restricted if the particles or the liquid powders can be moved and a contrast can be maintained, and it is adjusted normally to 10-500 μm, preferably 10-200 μm.

Moreover, it is preferred to control a volume occupied rate of the particles or the liquid powders within a gas in a space between the opposed substrates to 5-70 vol %, more preferably 5-60 vol %. If the volume occupied rate of the particles or the liquid powders exceeds 70 vol %, the particles or the liquid powders become difficult to move, and if it is less than 5 vol %, a sufficient contrast cannot be obtained and a clear image display is not performed.

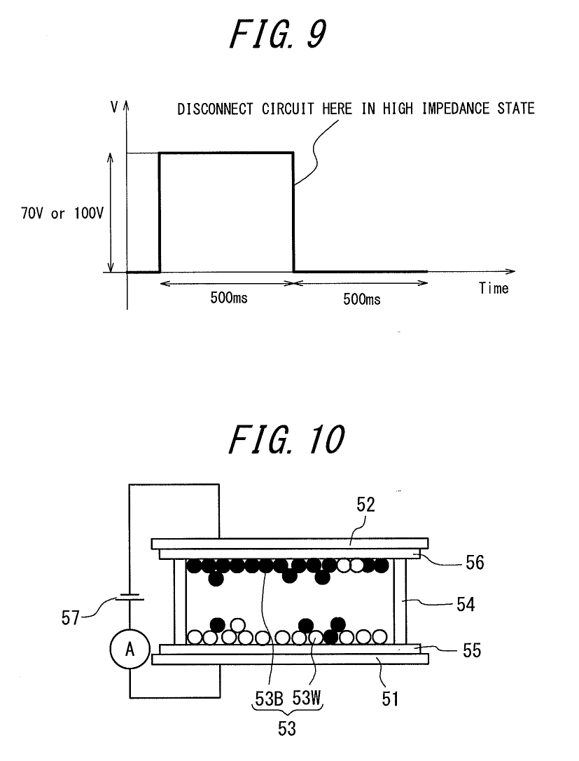

By use of three different kinds of information display panels A, B and C, the display media of the white color and of the black color were moved in accordance with a voltage application pattern by a drive method shown in FIG. 9, so as to display the white color or the black color on the entire display. In an example according to the present invention to set the high impedance state at lowering of the pulse voltage, the circuit between the electrodes was disconnected at lowering of the voltage shown in FIG. 9. In an example according to the conventional art to set the voltage 0V at lowering of the pulse voltage, the voltage application pattern was the one at lowering of the voltage shown in FIG. 9. In addition, in order to display the white color on the entire display, a ROW side was set to be 0V, while a COL side was set at 70V or 100V at an input of the voltage application pattern shown in FIG. 9. In order to display the black color on the entire display, the ROW side was set at 70V or 100V, while the COL side was set at 0V at the input of the voltage application pattern shown in FIG. 9.

After 20,000 times of repetition of each of the white color display and of the black color display both on the entire display, a value of an optical density (OD) at the white color display on the entire display was obtained as OD (White) and the a value of OD at the black color display on the entire display was obtained as OD (Black). A contrast Cr was calculated by the following formula:

Cr=10̂(OD(Black)−OD(White))

and the example according to the present invention and the example according to the conventional art were compared to one another based on the contrast. Results are shown in Table one shown below.

TABLE 1

| | | Example According to | | Example According to | | | |
|---|---|---|---|---|---|---|---|
| | | Conventional Art | | Present Invention | | Example According to | Example According to |
| Panel | Driving | (Fall Time) | | (High Impedance) | | Conventional Art | Present Invention |
| No. | Voltage | OD (Black) | OD (White) | OD (Black) | OD (White) | Cr | Cr |
| A | 100 V | 1.486 | 0.734 | 1.505 | 0.690 | 5.65 | 6.53 |
| | 100 V | 1.475 | 0.709 | 1.520 | 0.663 | 5.83 | 7.19 |
| B | 100 V | 1.419 | 0.705 | 1.468 | 0.686 | 5.18 | 6.05 |
| C | 100 V | 1.454 | 0.710 | 1.502 | 0.655 | 5.55 | 7.03 |
| | 100 V | 1.444 | 0.697 | 1.492 | 0.657 | 5.58 | 6.84 |
| | 70 V | 1.409 | 0.715 | 1.438 | 0.676 | 4.94 | 5.78 |

In comparison with the example according to the present invention and the example according to the conventional art based on the results in Table 1, it is revealed that a value of Cr in accordance with the present invention exceeds that a value of Cr accordance with the conventional art by 1 or more when a drive voltage is 100V (1 pulse input). Moreover, it is also revealed that the value of Cr in accordance with the present invention exceeds the value of Cr in accordance with the conventional art nearly by 1 when the drive voltage is 70V.

### INDUSTRIAL APPLICABILITY

The information display panel, to which the drive method according to the invention is applicable, is suitably used for image display units of portable information equipments such as laptop computers, electronic datebooks, portable information equipment called as PDA (Personal Digital Assistants); display units of mobile equipments such as cellular phones, handy terminals and so on; the electric paper for electronic books, electronic newspaper, electronic manuals (electronic instruction manuals), caution labels and so on; bulletin boards such as signboards, posters, blackboards, whiteboards and so on; display units of electronic desk calculators, home electric appliances, auto supplies and so on; card display units of point cards, IC cards and so on; and display units of electronic advertisements, information boards, electronic POP (Point of Presence, Point of Purchase advertising), electronic price tags, electronic bin tags, electronic musical scores, RF-ID devices and so on, as well as display units of electronic devices such as POS terminals, car navigation equipment, clocks, and so on.

1. A drive method of an information display panel constituted of two substrates, at least one of which is transparent, and display media sealed therebetween, for displaying information such as an image by applying a pulse voltage between electrodes provided to each of the substrates facing one another so as to apply an electric field to the display media, is characterized in lowering the pulse voltage by setting a circuit between the electrodes, to which the pulse voltage is applied, a high impedance state.

2. The drive method of the information display panel according to claim 1, wherein the high impedance state is achieved by disconnection of the circuit between the electrodes.

3. The drive method of the information display panel according to claim 1, wherein the display media are a particle group or liquid powder composed of at least one kind of particles.
